(19) United States
(12) Patent Application Publication
(10) Pub. No.: US 2014/0118246 A1
(43) Pub. Date: May 1, 2014

(54) GESTURE RECOGNITION USING AN ELECTRONIC DEVICE INCLUDING A PHOTO SENSOR

(71) Applicant: PANTECH CO., LTD., Seoul (KR)

(72) Inventors: Seung-Hwan PARK, Seoul (KR); Woo-Jin Lee, Seoul (KR); Jang-Bin Yim, Seoul (KR)

(73) Assignee: PANTECH CO., LTD., Seoul (KR)

(21) Appl. No.: 14/069,717

(22) Filed: Nov. 1, 2013

(30) Foreign Application Priority Data
Nov. 1, 2012 (KR) 10-2012-0123183

(51) Int. Cl. G06F 3/01; G06F 3/03

(52) U.S. Cl. CPC G06F 3/017; G06F 3/0304
USPC 345/156

(57) ABSTRACT

An electronic device including a photo sensor and a gesture recognition module, and method for the electronic device are provided. The photo sensor emits infrared light, receives reflected light from an external object to which the IR light has been emitted, and generates reflected light data. Then, the gesture recognition module determines a motion or a cover state of an external object as a predefined gesture input type using the reflected light data. The gesture input type includes at least two or more types of motions or cover inputs indicating different cover states of different durations.

### CROSS-REFERENCE TO RELATED APPLICATION

This application claims priority from and the benefit under 35 U.S.C. §119(a) of Korean Patent Application No. 10-2012-0123183, filed on Nov. 1, 2012, which is hereby incorporated by reference in its entirety for all purposes as if fully set forth herein.

### BACKGROUND

1. Field

Exemplary embodiments of the present invention relate to gesture recognition, and more particularly, to an electronic device including a photo sensor, a method of controlling the electronic device, and a gesture recognition apparatus and method for the electronic device.

2. Discussion of the Background

With the development of information communication technologies, electronic devices have diversified. Especially, handheld electronic devices, such as, smartphones, tablet computers, portable multimedia players (PMPs), MP3 players, navigation devices, and the like, have been more generally used and developed. New functions are increasingly added to electronic devices and the electronic device can be equipped with a new sensing input device that recognizes various inputs and gestures of a user to enhance convenience of use.

A gesture detection apparatus may be one of examples of a new user input device. The gesture detecting apparatus can recognize a physical object, for example, a user's hand, placed, near and sometimes without contacting the electronic device. The gesture detecting apparatus may include a touch screen or a photo sensor. A touch screen as a gesture sensor is capable of recognizing user's actual touch and motion on the touch screen, whereas the photo sensor as a gesture sensor is capable of recognizing a user's motion that is performed not in direct contact with the electronic device. Thus, the photo sensor has gained increasing attention as an auxiliary input device to overcome drawbacks of the touch screen. The photo sensor as a new user input device is capable of receiving various types of inputs and improving convenience of use.

Various sensing assemblies including one or more light emitting units and one or more light receiving units, and a gesture recognition method using the sensing assembly have been investigated. To recognize a variety of gestures (for example, push/pull gestures in the Z-axial direction, a slide gesture on the X-Y plane, a hovering gesture without moving for a predefined period of time) in a three-dimensional space, the one or more light emitting unit and the one or more light receiving units, which constitute the sensing assembly, vary in structure and are arranged in various ways.

However, conventional electronic devices, each including the above sensing assembly or other existing photo sensors, may fail to accurately recognize a user's gesture and, even if they succeed, may not utilize the recognized user gesture as a valid gesture input. In particular, there has not been disclosed a method for recognizing a gesture corresponding to, for example, the “hovering gesture”, where a user does not either move an object or a user's finger at a particular location (for example, a primary light path of light emitted from the light emitting unit of the photo sensor) for a certain period of time or any specific method for utilizing the recognized gesture as a gesture input for performing an action of the electronic device.

### SUMMARY

Exemplary embodiments of the present invention provide an electronic device including a photo sensor, a method of controlling the electronic device, and a gesture recognition apparatus and method for the electronic device.

Additional features of the invention will be set forth in the description that follows, and in part will be apparent from the description, or may be learned by practice of the invention.

According to exemplary embodiments, there is provided an electronic device including: a gesture recognition module configured to receive reflected light data, configured to determine one or more of a motion and a cover state of an external object using the reflected light data, and configured to recognize the motion or the cover state as a gesture input type, wherein the gesture input type includes two or more types of motions or cover inputs indicating different cover states of different durations; and a processor configured to execute the gesture recognition module.

According to exemplary embodiments, there is provided an electronic device including: a gesture recognition module configured to receive reflected light data, configured to determine one or more of a motion, a release and a cover state of an external object using the reflected light data, and configured to recognize the motion, release or cover state immediately preceding the release state as a gesture input type; and a processor configured to execute the gesture recognition module.

According to exemplary embodiments, there is provided a computer-implemented method of recognizing a gesture, the method including: receiving, with the computer, reflected light data; determining, with the computer, one or more of a motion and a cover state of an external object using the reflected light data; and recognizing, with the computer, the motion or the cover state as a gesture input type, wherein the gesture input type includes two or more types of motions or cover inputs indicating different cover states of different durations.

According to exemplary embodiments, there is provided a computer-implemented method of recognizing a gesture, the method including: receiving reflected light data; determining one or more of a motion, a release and a cover state of an external object using the reflected light data; and recognizing the motion, release or cover state immediately preceding the release state as a gesture input type.

It is to be understood that both the forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings provide a further understanding of the invention and are incorporated in and constitute a part of this specification, illustrate embodiments of the invention, and together with the description serve to explain the principles of the invention.

FIG. 1 illustrates an electronic device including a photo sensor according to exemplary embodiments of the present invention.

FIG. 2 illustrates a configuration of a photo sensor according to exemplary embodiments of the present invention.

FIG. 3 illustrates a configuration of an electronic device including a photo sensor according to exemplary embodiments of the present invention.

FIG. 4 illustrates a gesture recognition process according to exemplary embodiments of the present invention.

FIGS. 5A to 5D are exemplary graphs illustrating photo data output by a photo sensor in accordance with a moving direction of an object, with FIG. 5A relating to an upward direction, FIG. 5B to a downward direction, FIG. 5C relating to a left direction and FIG. 5D relating to a right direction.

FIGS. 6A to 6D are exemplary graphs showing a variation (delta X) of the intensity of the reflected light in an X-axis direction and a variation (delta Y) of the intensity of the reflected light in a Y-axis direction, calculated using the reflected light data shown in FIGS. 5A to 5D.

FIG. 7 illustrates exemplary cover events and release events.

FIG. 8 is a flowchart illustrating a gesture recognition method for a photo sensor according to exemplary embodiments of the present invention.

FIG. 9 is a flowchart illustrating a method for controlling an electronic device according to exemplary embodiments of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first,” “second,” and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

In addition, embodiments described in the specification are wholly hardware, and may be partially software or wholly software. In the specification, “unit”, “module”, “device”, “system”, or the like represents a computer related entity such as hardware, combination of hardware and software, or software. For example, in the specification, the unit, the module, the device, the system, or the like may be an executed process, a processor, an object, an executable file, a thread of execution, a program, and/or a computer, but are not limited thereto. For example, both of an application which is being executed in the computer and a computer may correspond to the unit, the module, the device, the system, or the like in the specification.

The term “event” indicates any sort of executable element of an application. Event may refer to a process of an application, a task of an application, or the application itself. Further, the various terms described above may be substituted with each other according to various aspects described within the disclosure.

The term “gesture” describes a motion of an external object, for example, a user's hand, a finger, or an object. The external object can be moving, for example, left, right, upward and downward relative to a photo sensor; the external object can be still or not moving. A still state may include a cover state depending on its duration. A state of the object, for example, a state in which the user's hand or finger covers the photo sensor or a state in which the user removes his/her hand or finger from the covered photo sensor). The “gesture” may include a “direction” gesture that refers to a motion of an object moving in a direction, for example, up, down, left, and right, relative to a photo sensor, a “cover” gesture that refers to a state in which the object pauses and covers the photo sensor, and a “release” gesture that refers to a state in which the object does not cover the photo sensor any longer after the cover gesture.

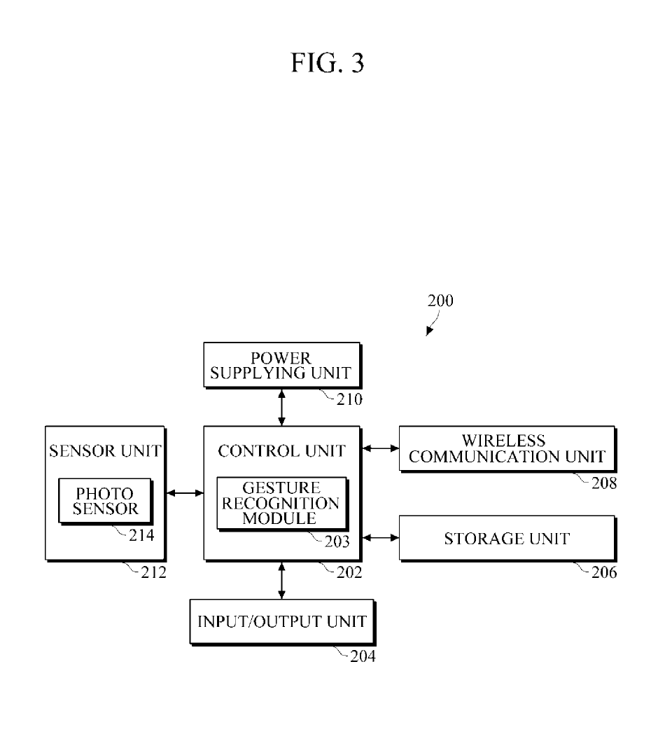

The term “gesture recognition” refers to recognizing a gesture to generate a gesture event and determining the presence/absence and/or the type of gesture input. The procedure and method for gesture recognition is not limited, and according to exemplary embodiments of the present invention, a gesture may be recognized directly from photo data transferred from a photo sensor, or based on a direction signal, a release signal and/or a cover signal which have been determined based on the photo data and then sorted using a predefined process. Generally, those skilled in the art would use the terms “direction event” “release event” and “cover event” instead of the terms “direction signal,” “release signal,” and “cover signal,” respectively. In this disclosure, however, the terms “direction signal”, “release signal”, and “cover signal” are distinguished from the terms “direction event”, “release event”, and “cover event”, based on whether an application or a specific function determines the gesture input, as described later. The gesture recognition may be performed by a gesture recognition module 203 illustrated in FIG. 3.

The term “gesture input” may be related to an input signal in response to which an application or a specific function provided by or installed in an electronic device executes a particular action. The gesture input may include at least a “direction” input generated when an object moves in one direction, such as, up, down, left and right, relative to a photo sensor and a “cover” input generated when the object pauses while covering the photo sensor. In addition, the gesture input may further include a “wipe” input generated when the object moves up and down or left and right relative to the photo sensor.

According to exemplary embodiments of the present invention, a gesture recognized by a gesture recognition module (that is, a gesture event generated in a lower level because of recognition) does not necessarily correspond one-to-one to a gesture input for execution of an application or a specific function. In other words, the application or the specific function installed in an electronic device does not always confirm the occurrence of a gesture input even when receiving one or more gesture events from the gesture recognition module. However, the application or the specific function may be able to confirm the presence of the gesture input based on only a single gesture event. The application or the specific function may determine the occurrence of the gesture input based on one gesture event or a combination of two or more gesture events according to the type and/or order of gesture events, described later.

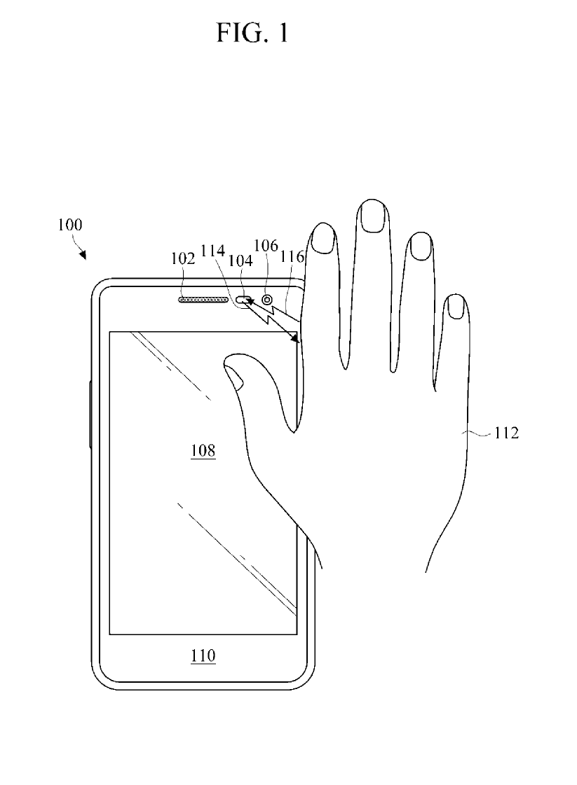

FIG. 1 illustrates an electronic device including a photo sensor according to exemplary embodiments of the present invention. Electronic device 100 is capable of detecting a motion and/or a state of an object outside and determining the detected motion or state as a gesture input. As shown in FIG. 1, the electronic device 100 may be a portable device, such as, a smartphone, which is provided for exemplary purposes only. For example, electronic device 100 may be a handheld device, such as, a mobile phone, an MP3 player, a digital camera, a portable multimedia player, a navigation device, a portable game player, an electronic dictionary device, an E-book reader, a digital multimedia broadcasting receiver, a smartphone, a tablet PC, and the like. Electronic device 100 may be a stationary device equipped with a photo sensor for gesture detection and may include, for example, a television, a vending machine, a vehicle, an automated teller machine (ATM), an unmanned automatic guidance device, and the like.

As illustrated in FIG. 1, the electronic device 100 includes a photo sensor 104 to detect a motion and/or a state of an object 112, for example, a user's hand, outside the electronic device 100. The photo sensor 104 enables the electronic device 100 to recognize one or more gesture inputs. For the recognition of the gesture input, the photo sensor 104 generates photo data containing information about the presence and/or the location of the object 112. The photo detector 104 periodically emits light 114 and receives light 116 reflected from the object 112. The photo data may be reflected-light data that is generated from the reflected light 116, but the type of photo data is not limited thereto. The photo sensor 104 may be positioned within a predefined region of the electronic device 100. For example, the photo sensor 104 may be disposed on an upper front part of the electronic device 100

The electronic device 100 may include a speaker 102 for audio output, an image capturing device 106, a touch screen 108, and the like. Although not illustrated, one or more input buttons or input keys may be provided on an outer region of the touch screen 108, for example, a lower region 110 of the touch screen. The configuration of the electronic device 100 or the arrangement of elements thereof is provided for exemplary purposes only. The exemplary embodiments of the present invention are not limited to the particular electronic device (smartphone) illustrated in FIG. 1 and even if aspects of the present invention are applied to the same type of electronic device (smartphone), it would be clearly understood by those skilled in the art that the exemplary embodiment is not limited to the electronic device with the same configuration, design and functions as the electronic device shown in FIG. 1.

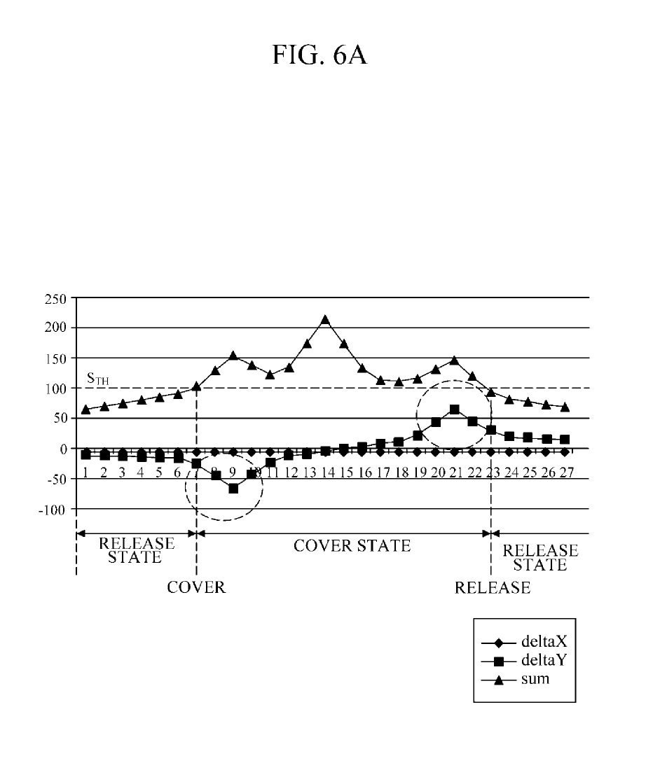

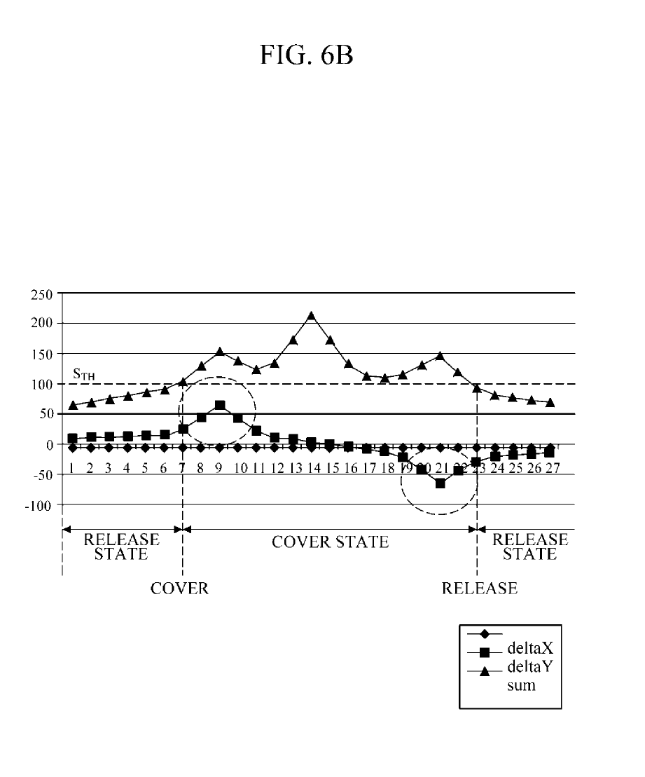

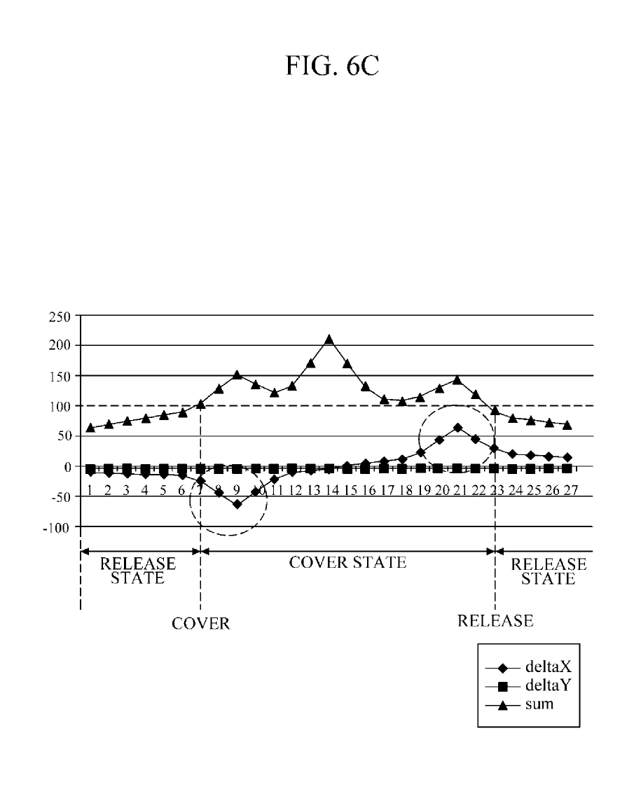

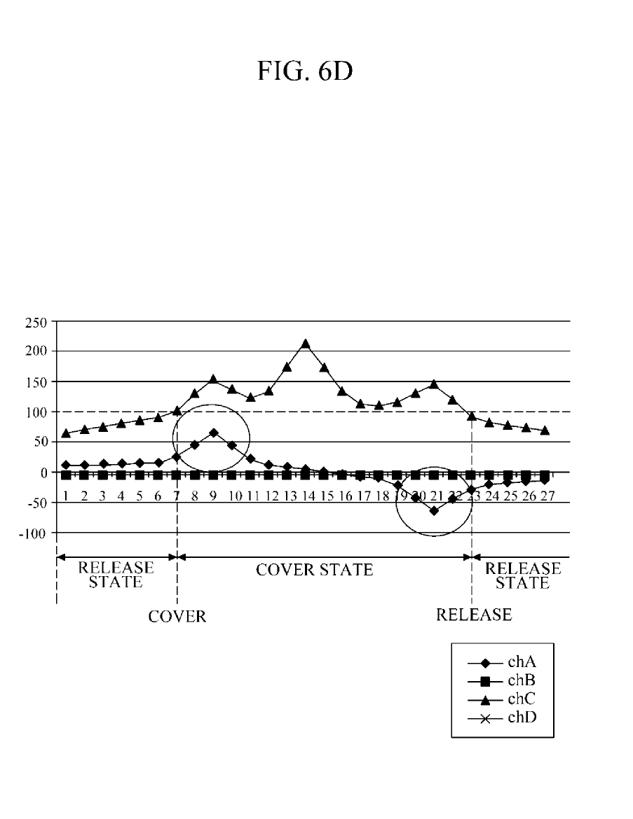

The electronic device 100 may determine a motion of an external object or a covering state thereof as a predefined gesture input using the photo data (for example, reflected light data) generated by the photo sensor 104. As described later, according to an exemplary embodiments of the present invention, the gesture input may include a “direction” input and two or more kinds of “cover” inputs. The direction input indicates an input generated by a motion of the object 112 moving upward, downward, left or right relative to the photo sensor 104, and may include an upward input, a downward input, a right-to-left input, and a left-to-right input. The cover input indicates an input generated when the object 112 is in a “cover” state relative to the photo sensor. The cover state indicates a state in which the object 112 pauses on a primary light path of the emission light 114 from the photo sensor for a period of time, and the “primary light path” indicates a location where the intensity (quantity) of light which has been reflected by an object placed at a specific location and is received by the photo sensor 104 is greater than a threshold (refer to FIGS. 6A to 6D). The types of cover input may vary with a period for which the cover state lasts. For example, the cover input may include a 1-second cover input and a 3-second cover input, which, respectively, indicate that the cover state lasts for one second and for three seconds.

In one aspect of the exemplary embodiments, the gesture input may further include a “wipe” input. The wipe input indicates an input generated by a reciprocating motion of the object 112 moving upward and downward or left to right or right to left once or more, relative to the photo sensor 104. In this case, according to exemplary embodiments, an up-to-down reciprocating motion and a down-to-up reciprocating motion and/or a left-to-right reciprocating motion and right-to-left reciprocating motion may be recognized as the same gesture input or as different gesture inputs.

Additionally, the electronic device 100, and more specifically, an application or a function executed in the electronic device 100 performs a particular action to correspond to the determined gesture input. That is, a control unit 202 (refer to FIG. 3) of the electronic device 100 controls other elements to process a particular input related to the application or the function running in the electronic device 100 so as to correspond to the determined gesture input. An action to be performed by the electronic device 100 corresponding to the determined gesture input may be varied according to rules predefined for individual types of application or function. The rules may be arbitrarily determined, or, preferably, determined based on a typical meaning of the gesture input, that is, in accordance with the user and/or electronic device's typical recognition of the gesture input for each application or function, for the convenience of the user.

Examples of actions executable by the electronic device 100 according to the gesture input 100 are shown in Table 1. The applications or functions provided by the electronic device 100 may utilize the gesture inputs shown in Table 1 and the corresponding applicable actions according to their needs. For example, the applications or the functions to utilize the actions may include multimedia players for a browser, images, music, and videos, a voice call function, a scheduler, and mails, and the type of application and function is not limited thereto.

TABLE 1

| | Gesture | |
|---|---|---|
| Gesture Input | Meaning | Applicable Action(s) |
| Left-to-Right Input | Turn, Tap | Paging (Next), Rewind |
| Right-to-Left Input | Turn, Tap | Paging (Previous), Fast Forward |
| Upward Input | Turn, Tap | Scrolling (Upward), Level- |
| | | Adjusting (Upward) |
| Downward Input | Turn, Tap | Scrolling (Downward), Level- |
| | | Adjusting (Downward) |
| | Wipe, Shake | Answer Call |
| First Cover (1 Sec.) | Quick-Cover | Start/Pause |
| Second Cover (3 Sec.) | Long-Cover | Terminate |

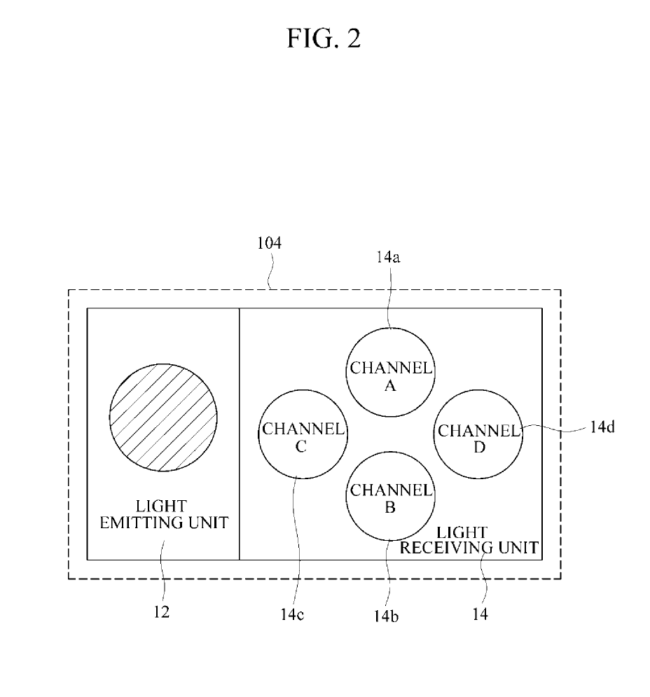

FIG. 2 is a diagram illustrating an example configuration of the photo sensor 104 shown in FIG. 1. As described above, the photo sensor 104 equipped in the electronic device 100 (refer to FIG. 1) may be any type of device which is capable of generating photo data containing information about the presence and/or location of an object outside, for example, a user's hand, such that the motion and/or the state of the user's hand can be detected. The type of photo sensor is not limited. For example, the photo sensor 104 may not be limited to an IR sensor with the configuration as shown in FIG. 2, and may be an IR sensing assembly with various configurations known in the art. Hereinafter, the functions and operation of the photo sensor 104 will be described in detail with reference to FIG. 2.

FIG. 2 illustrates a configuration of a photo sensor according to exemplary embodiments of the present invention. The photo sensor 104 includes a light emitting unit 12 and a light receiving unit 14 neighboring or adjacent to the light emitting unit 12. In some embodiments, a light emitting unit 12 and a light receiving unit 14 may be integrated into one unit. The light receiving unit 14 may be disposed along other edges, for example, top, bottom, or right edge, of the light emitting unit 12. Light receiving units may surround or partially surround the light emitting unit 12. The light emitting unit 12 may emit Infra-Red (IR) light. The emitted IR light can be reflected from an external object, and the reflected light can be received the light receiving unit 14. Thus, the light emitting unit 12 and the light receiving unit 14 may be disposed close to each other, and they may be disposed at a predetermined interval for design or optical purposes. The emitted light can have a wavelength that is not generally found in ambient light, for example, an IR light.

The light emitting unit 12 periodically emits IR light. The interval at which the light emitting unit 12 emits IR light may be, but not necessarily, short enough to allow the recognition of gesture input. The interval for emitting light may depend on power consumption considerations. For example, the interval may be less than 10 milliseconds (ms), for example, about 6.5 ms, about 5 ms, about 3 ms or the like.

The light receiving unit 14 receives the reflected light and periodically generated photo data that the electronic device 100 (refer to FIG. 1) is capable of using in detecting a motion direction or a state of the object. To this end, the light receiving unit 14 may include a plurality of unit light receivers 14a, 14b, 14c, and 14d arranged in formation. Here, the unit light receivers 14a, 14b, 14c, and 14d may be minimum units for detecting periodically received light and generating photo data. The unit light receivers 14a, 14b, 14c, and 14d may detect the reflected light at each interval and generate the photo data, for example, the intensity of the reflected light. The unit light receivers 14a, 14b, 14c, and 14d may be implemented as individual light receiving modules and/or a group of light receiving modules.

For example, the four unit light receivers 14a, 14b, 14c, and 14d of the light receiving unit 14 may be arranged in a diamond formation, as shown in FIG. 2. The diamond formation is one of example arrangements for four unit light receivers 14a, 14b, 14c, and 14d, which is suitable to recognize the motion of an object in four directions including up, down, left, and right. The light receiving unit 14 may have unit light receivers arranged in a different formation, for example, eight unit light receivers arranged in a regular octagon, two light receivers arranged in a line, 3 receivers arranged in a triangle, and the like. An increase in the number of light receivers can provide a better resolution for the gesture motion, including direction or travel path. The arrangement of the light receiving unit 14 as shown in FIG. 2 may be utilized to recognize additional directions, for example, upper left, lower left, upper right, and lower right, other than the four directions, i.e., up, down, left and right.

FIG. 3 illustrates a configuration of an electronic device including a photo sensor according to exemplary embodiments of the present invention. Electronic device 200 may include the smartphone 100 as shown in FIG. 1, and is not limited thereto. The electronic device 200 includes a control unit 202 including a gesture recognition module 203, an input output unit, a storage unit 206, a wireless communication unit 208, a power supplying unit 210, and a sensor unit 212 including the photo sensor 214. The gesture recognition module 203 can be used to generate a gesture event using photo data generated by the photo sensor 214 to indicate a motion or a state of an object.

The electronic device according to aspects of the present invention does not need to include all modules shown in FIG. 3, and may exclude one or more modules. For example, the electronic device 200 may not include the wireless communication unit 208. The electronic device 200 may include additional modules for performing actions, and the additional modules may vary depending on the type or functions of the electronic device 200. For example, the electronic device 200 may include a vibration generating module, a global positioning system (GPS) module, a broadcast receiving module, a wired communication module, or the like.

The control unit 202 performs overall management, processing and control of necessary operations. For example, the control unit 202 may control operations or process signal to allow the electronic device 200 to perform, for example, data communication or voice or video call with a server or another electronic communication. The control unit 202 may control operations or process signals to execute a particular function module or program, for example, a game or multimedia playback. The control unit 202 may perform predefined processing in response to a visual, aural, or mechanical input signal received from an input module of the input/output unit 204 or from the sensor unit 212, and may control an output module of the input/output unit 204 to output the processing result of the input signal and/or the relevant execution result of the input signal as a visual, aural, or mechanical signal.

The control unit 202 may operate to support the gesture recognition function of the electronic device 200. To support the gesture recognition function, the control unit 202 may recognize a motion or a state, that is, a gesture, of an external object using the photo data input from the photo sensor 214 of the sensor unit 212, for example, an IR sensor, and determine the recognized gesture as a particular gesture input.

For example, the control unit 202 may include a gesture recognition module 203 for recognizing a gesture of the object 112 (refer to FIG. 1). In detail, the gesture recognition module 203 may recognize the gesture using the photo data received from the photo sensor 214 and generate a gesture event because of the recognition. The gesture event may include, at least, a “direction” event related to left, right, up and down direction, a “cover” event, and a “release” event. In addition, the direction event may include an “up” event, a “down” event, a “left” event, and a “right” event.

Hereinafter, an example applying the gesture recognition module 203 on an operating system (OS) of a portable electronic device is described. Generally, a portable electronic device primarily includes of a hardware layer, a platform for processing a signal received from the hardware layer and transferring the signal, and an application layer for running various applications, on the platform. Exemplary OSs of the electronic device include the ANDROID platform, WINDOWS MOBILE platform, IOS platform, or the like. These platforms may be slightly different from each other in their structure, but serve substantially the same functions. The ANDROID platform includes of the LINUX kernel layer, the library layer, and the framework layer. The WINDOWS MOBILE platform includes of the WINDOWS Core layer and the interface layer. The IOS platform includes of the core OS layer, the core service layer, the media layer and the COCOA TOUCH layer. Each layer may be represented as a block, and the framework layer of the ANDROID platform and similar layers of other platforms may be defined as software blocks.

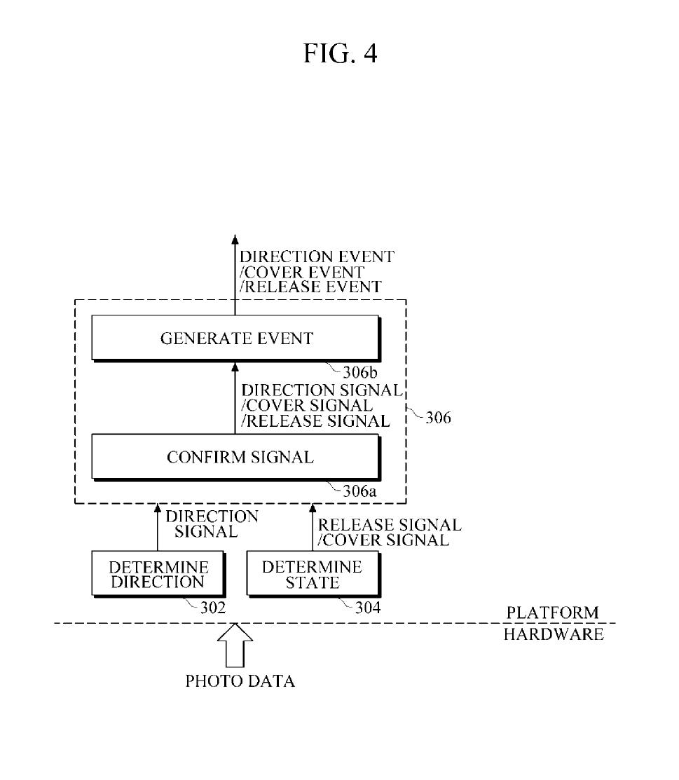

FIG. 4 illustrates gesture recognition process according to exemplary embodiments of the present invention. The example shown in FIG. 4 may be implemented on a mobile OS, for example, ANDROID OS, and is not limited thereto. In FIG. 4, a gesture recognition module 203 of FIG. 3 includes a direction determining unit 302, a state determining unit 304 and a gesture recognition unit 306 on the platform or a software block. Hereinafter, to avoid redundancy, the implementation of the gesture recognition module 203 will be described in brief. Details that are not described herein may be the same as the description provided with reference to FIGS. 1 to 3.

The direction determining unit 302 determines a moving direction of the object 112 (refer to FIG. 1) using photo data received from the hardware layer and generates a direction signal indicating the determined moving direction. The photo data may be periodically transmitted to the direction determining unit 302 from the hardware layer. The direction signal from the direction determining unit 302 may be a signal indicating one of up, down, left and right directions, but is not limited thereto. A method used for the direction determining unit 302 to determine the direction using the photo data may vary depending on a type of the hardware device, that is, the photo sensor 104 (refer to FIG. 1), which provides the photo data. In the present exemplary embodiments, the method used by the direction determining unit 302 is not limited. Hereinafter, a method of determining a direction using the photo sensor 104 shown in FIG. 2 is described.

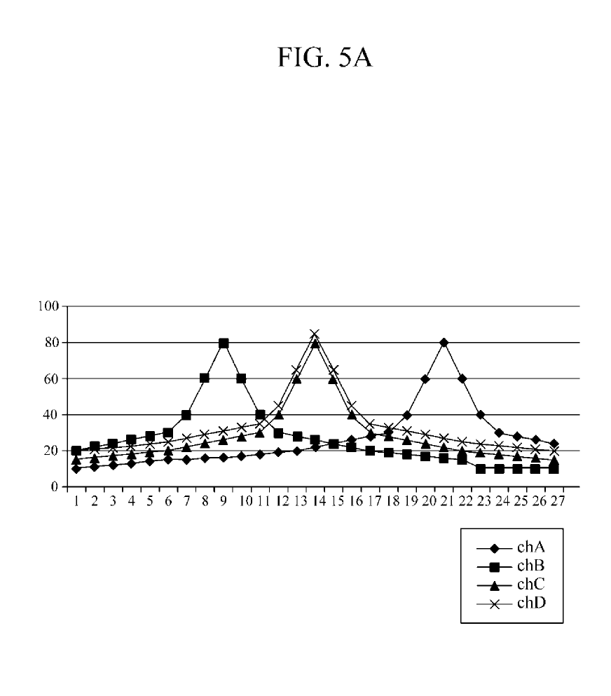

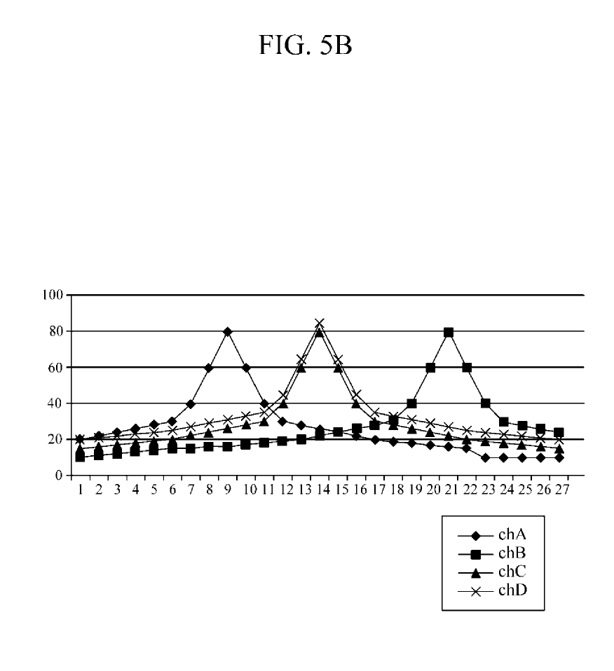

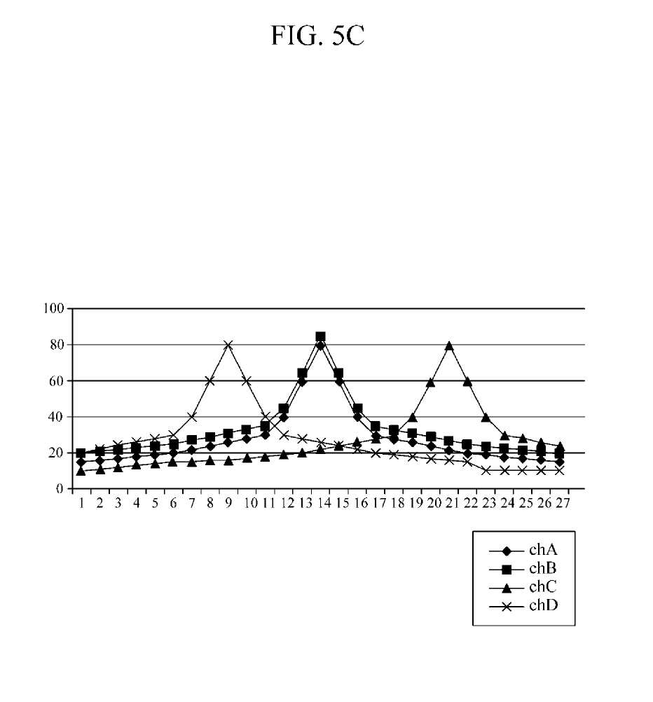

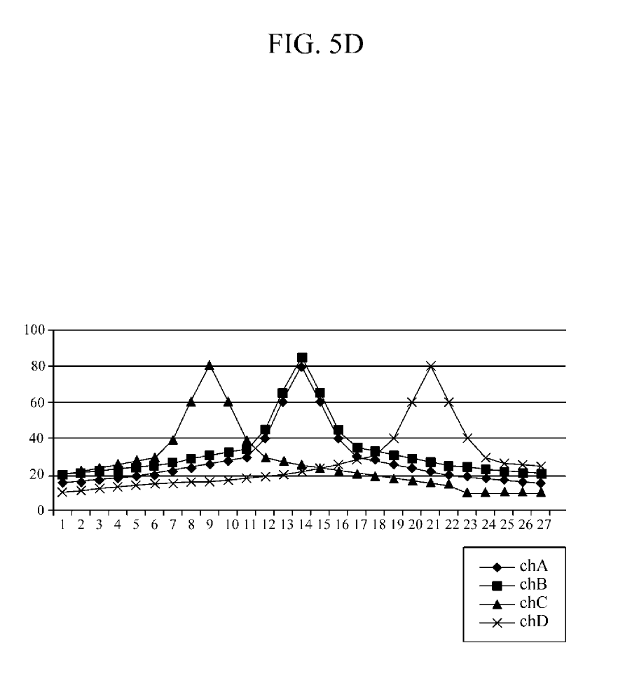

FIGS. 5A to 5D are exemplary graphs illustrating photo data output by a photo sensor in accordance with a moving direction of an object, with FIG. 5A relating to an upward direction, FIG. 5B relating to a downward direction, FIG. 5C relating to a left direction and FIG. 5D relating to a right direction. In FIGS. 5A to 5D, “chA,” “chB,” “chC,” and “chD” represent photo data related to reflected light received from a channel A light receiver 14a, a channel B light receiver 14b, a channel C light receiver 14c, and a channel D light receiver 14d, respectively. In addition, in FIGS. 5A to 5D, a horizontal axis represents time, and more specifically, the number of intervals (for example, 6.5 ms), and a vertical axis represents relative intensity or strength of the reflected light being received by each channel light receiver.

FIG. 5A relates to an upward moving direction, with the light receivers sequentially showing the maximum intensity of reflected light in the order of chB, chC/chD and chA. FIG. 5B relates to a downward moving direction, with the light receivers sequentially showing the maximum intensity of reflected light in the order of chA, chC/chD and chB. FIG. 5C relates to a left moving direction, with the light receivers sequentially showing the maximum intensity of reflected light in the order of chD, chA/chB and chC. FIG. 5D relates to a right moving direction, with the light receivers sequentially showing the maximum intensity of reflected light in the order of chC, chA/chB and chD. As such, the direction determining unit 302 may determine the moving direction based on a temporal order of the light receivers showing the maximum intensity of reflected light within, a period, i.e., a predetermined number of intervals.

In some embodiments, the direction determining unit 302 may determine the moving direction based on variation in the intensity of the reflected light in an X-axis (horizontal) direction and a Y-axis (vertical) direction within a period. FIGS. 6A to 6D are exemplary graphs showing a variation (delta X) of the intensity of the reflected light in an X-axis direction and a variation (delta Y) of the intensity of the reflected light in a Y-axis direction, calculated using the reflected light data shown in FIGS. 5A to 5D. In FIGS. 6A 6 to 6D, the X-axial direction variation (delta X) is calculated as chC−chD, and the Y-axial direction variation (delta Y) is calculated as chA−chB. It may be appreciated that each variation can be calculated by reversing the terms. Further, FIGS. 6A to 6D show the sum (sum=chA+chB+chC+chD) of the intensity of reflected light received by the respective light receivers, each intensity being calculated using the reflected light data of FIGS. 5A to 5D.

FIG. 6A relates to an upward moving direction, as the X-axial direction variation (delta X) remains close to 0, and the Y-axial direction variation (delta Y) changes from a negative value to a positive value over time FIG. 6B relates to a downward moving direction, as the X-axial direction variation (delta X) remains close to 0, and the Y-axial direction variation (delta Y) changes from a positive value to a negative value. FIG. 6C relates to a left moving direction, as the X-axial direction variation (delta X) changes from a negative value to a positive value and the Y-axial direction variation (delta Y) remains close to 0. FIG. 6D relates to a right moving direction, as the X-axial direction variation (delta X) changes from a positive value to a negative value and the Y-axial direction variation (delta Y) remains close to 0.

Referring back to FIG. 4, the state determining unit 304 determines a state of the object 112 (refer to FIG. 1) using the photo data received from the platform hardware layer and generates a state signal indicating the determined state. The same photo data as transmitted to the direction determining unit 302 may be transmitted to the state determining unit 304 periodically from the hardware layer. The state signal may include at least a cover signal indicating a cover state and a release signal indicating a release state. A method used for the state determining unit 304 to determine a state using the photo data may vary depending on the type of the hardware device, that is, the photo sensor 104 (refer to FIG. 1), which provides the photo data. The method used by the state determining unit 304 to determine the state is not limited, and hereinafter, a method of determining the state using the photo sensor 104 shown in FIG. 2 will be described.

For example, the state determining unit 304 may use the sum of the intensity of the reflected light received by the respective light receivers shown in FIGS. 6A to 6D or use the average (sum/the number of light receivers) of the intensity of the reflected light so as to determine the state. For example, if the sum of the intensity of the reflected light is greater than a threshold (STH) (in FIGS. 6A to 6D, after “cover”), the state determining unit 304 may confirm the cover state, and when the sum of the intensity of the reflected light is smaller than the threshold (STH) (in FIGS. 6A to 6D, before “cover” and after “cover”), the state determining unit 304 may confirm the release state. In some exemplary embodiments, the state determining unit 304 may determine the release state only after determining the cover state once or more, that is, only when the sum of the intensity of the reflected light has been once greater than the threshold (STH) and then thereafter becomes lower than the threshold.

The gesture recognizing unit 306 generates a gesture event using the direction signal received from the direction determining unit 302 and the cover signal and release signal received from the state determining unit 304. As described above, the gesture event may be one of the direction event, the cover event, and the release event. More specifically, the gesture recognizing unit 306 may generate one or more gesture events according to the combination of one or more direction signal, one or more cover signal and/or a release signal, each of which is received within a predefined period. In addition, signals belonging to the combination of the direction signal, the cover signal, and/or the release signal, which is used for generating the gesture event, include not all signals generated by the direction determining unit 302 and the state determining unit 304, but only some signals selected in accordance with predefined criteria.

To this end, the gesture recognizing unit 306 may include a signal confirming unit 306a and an event generating unit 306b. The signal confirming unit 306a may select signals for use in generating the gesture event from among the one or more cover signals and/or the release signal generated by the direction determining unit 302. In addition, if the signal or the combination of the signals selected by the signal confirming unit 306 corresponds to a predefined signal combination for each event, the event generating unit 306b may generate the corresponding gesture event.

More specifically, the signal confirming unit 306a may select one or more signals from among one or more direction signals and/or one or more cover signals generated and input before the generation and input of a release signal. In this case, the one or more signals selected by the signal confirming unit 306a may be transmitted to the event generating unit 306b, along with the reference release signal, sequentially and in the order in which the signals are generated.

According to exemplary embodiments, when a number of direction signals are consecutively input before the release signal, the signal confirming unit 306a may select only a last direction signal, i.e., the signal input immediately before the reference release signal. In this case, if a cover signal is input right before the input of the release signal, the signal confirming unit 306a may choose the cover signal over the other direction signals.

Table 2 shows examples of a signal that can be selected to be transmitted to the event generating unit 306b by the signal confirming unit 306a from among the combination of a number of signals input from the direction determining unit 302 and/or the state determining unit 304. In Table 2, the combination of input signals shown in the bottom row can be generated when two release signals are present. When two release signals are present, for example, the signal confirming unit 306a may select two signals based on the respective release signals as reference signals in accordance with the same rules as applying to the other examples.

TABLE 2

| Combination of Input Signals | Selected Signal |
|---|---|
| Left −> Right −> Release | Right |
| Right −> Left −> Release | Left |
| Up −> Down −> Release | Down |
| Down −> Up −> Release | Up |
| Cover −> Release | Cover |
| Left −> Up −> Right −> Down −> Right −> Release | Right |
| Left −> Up −> Release −> Right −> Down −> Right −> | Up −> Right |
| Release | |

As shown in Table 2, if the signal confirming unit 306a selects one signal from a number of direction signals generated before a release signal and transmits the selected signal to the event generating unit 306b, an error in recognizing a gesture due to tremor and inadvertent movement of the object may be decreased. Generally, since the photo sensor 104 (refer to FIG. 1 or 2) is very sensitive to motions, the photo data generated by the photo sensor 104 may differ before and after detection of small movement. Accordingly, the direction determining unit 302 and/or the state determining unit 302 may generate different signals before and after the detection of the small movement. It may be difficult to recognize an accurate gesture, if the gesture recognizing unit 306 determines a gesture based on all the signals generated by the direction determining unit 302 and/or the state determining unit 302. However, if the gesture recognizing unit 306 determines a gesture using the signals selected based on the release signal, as described above, difficulties or errors in recognizing a gesture caused, for example, by the small and inadvertent movement of the object, may be decreased.

The small movement or tremor may occur when the object moves or makes a motion. The small movement or tremor may frequently occur especially when the object remains still (in a cover state) at a particular location for a period. Thus, there is a need to decrease the gesture recognition error in an application, a function, or an electronic device providing such application or function. The decrease in error should be capable of recognizing the cover state of the object, determining the cover state as a gesture input and processing the gesture input. The need to decrease the gesture recognition error is more increased when the cover state of the object is divided into two or more cover inputs according to the lasting time of state, for example, when a cover state that lasts for a relatively long period is required.

In some embodiments, when receiving one or more direction signals and one or more cover signal before receiving a release signal as a reference signal, the signal confirming unit 306a may select the cover signal only and transmit the selected cover signal(s) to the event generating unit 306b. The signal confirming unit 306a may optionally select only the cover signal(s) by giving them priority and discard the direction signals, when receiving both the direction signals and the cover signals before receiving the reference release signal. Table 3 shows examples of one or more signals which are selected and transmitted by the signal confirming unit 306a to the event generating unit 306b when one or more direction signals and one or more cover signals are input to the signal confirming unit 306a.

TABLE 3

| Combination of Input Signals | Selected Signal |
|---|---|
| Left −> Cover −> Right −> Release | Cover |
| Left −> Up −> Right −> Cover −> Down −> | Cover |
| Right −> Release | |
| Left −> Cover −> Up −> Right −> Cover −> | Cover −> Cover |
| Down −> Right −> Release | |

Such rules are to decrease an error caused when both the direction signals and the cover signals are used as signals for gesture recognition. Thus, the signal confirming unit 306a may select the latest direction signal by giving priority to the received direction signals and transmit the selected direction signal to the event generating unit 306b when receiving one or more direction signals and one or more cover signals before receiving a release signal as a reference signal.

As described above, the event generating unit 306b may generate a gesture event from the signal or the combination of signals transmitted from the signal confirming unit 306a. The rules according to which the event generating unit 306g generates the gesture event from the received signal or combination of signals (i.e., rules for determining a gesture event corresponding to the received signal or combination of signals) may be predefined and implemented as a part of an action process of the event generating unit 306b. The event generating unit 306b may generate a gesture event corresponding to a predefined combination of signals for each event.

According to an example, the event generating unit 306b may generate a release event in response to a release signal. In some embodiments, the event generating unit 306b may generate a release event in response to the release signal only when one or more direction events or one or more cover events have been input prior to the input of a release signal.

In some embodiments, once a number of consecutive cover signals have been input to the signal confirming unit 306a within a period before a release signal is input, the event generating unit 306b may generate a cover event. The event generating unit 306b may not generate a cover event when a number of consecutive cover signals are input within a period shorter than the predefined period prior to the input of release signal. The event generating unit 306b may generate two or more cover events, if a number of consecutive cover signals are input within a period that is greater than twice the predefined period.

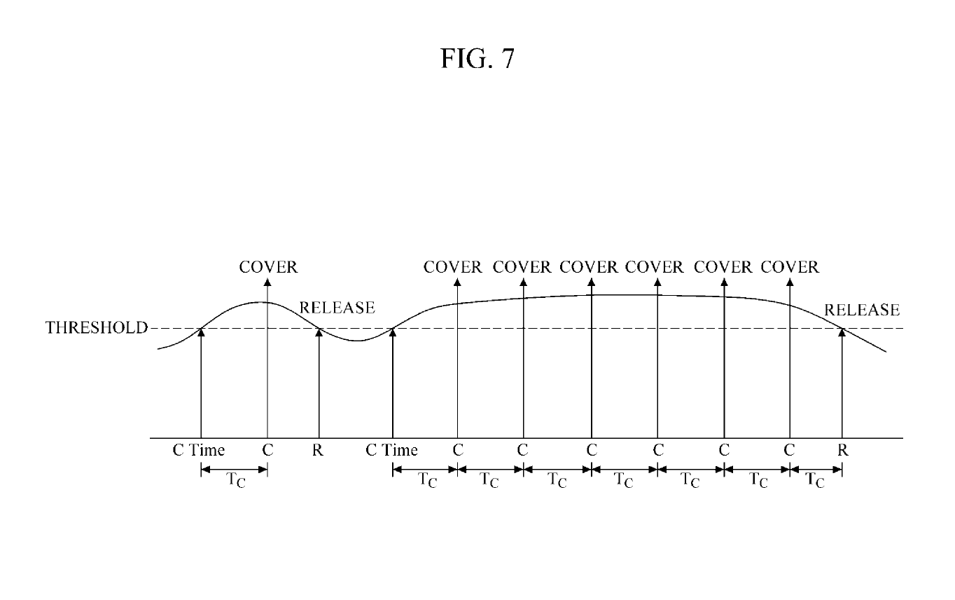

FIG. 7 illustrates exemplary cover events and release events. The cover events and release events be generated by the gesture recognizing unit 306, for example, with the event generating unit 306b. In FIG. 7, a line on a graph may represent photo data generated by the photo sensor 104 (refer to FIG. 2). The line can be a curved line. The line can represent, for example, the sum (sum=chA+chB+chC+chD) or the average (average=sum/4) of the intensity of the reflected light received by the respective right receivers of the photo sensor 104, and the representation can be plotted on the Y-axis A dotted line THRESHOLD parallel to the X-axis (a horizontal direction) represents a threshold to distinguish the cover state and the release state from each other. The state determining unit 304 can generate either the cover signal or the release signal based on the THRESHOLD. The graph can plot time on the X-axis. An event “C time” representing the time at which a cover state is initially determined. In FIG. 7, “C time” indicates a starting time of a timer that measures the duration of the cover state, reference letter C represents the time at which a cover event “COVER” occurs and reference letter R represents the time at which a release event “RELEASE” occur. “C Time” or an interval Tc between C time and C or between “C”s indicates an interval at which the cover event occurs, that is, the duration of each of the consecutive cover signals. Referring to FIG. 7, cover events can be generated one by one at predefined time intervals Tc during which the cover signals are consecutively generated before the time R at which the release event occurs.

In exemplary embodiments, the time required to generate one cover event, during which a number of cover signals are consecutively input, may be a specific period and may be arbitrarily established. As an example, the required time may be determined by considering the duration of a cover state for a cover input that is determined by the control unit 202 (refer to FIG. 3). For example, when the cover input includes one-second cover input and three-second cover input, the required time may be set to be shorter than one second, (for example, 500 ms which is half of the duration of the one-second cover input).

In exemplary embodiments, even when a release signal is input after a number of cover signals are successively input, if a cover event has not been yet generated (that is, a time for which the number of cover signals are input is shorter than the time required to generate the cover event), the event generating unit 306a may not generate a release event despite of the input of the release signal. That is, the event generating unit 306a may generate a release event when receiving a release signal only after having generated one or more cover events.

In some embodiments, when a release signal is input after a number of cover signals have been consecutively input, the event generating unit 306b may generate a direction event in response to a direction signal being input subsequent to the number of cover signals and prior to the release signal if a cover event has not been yet generated (that is, the time for which the number of cover signals are input is shorter than the time required to generate the cover event). In this case, once the direction event has been generated, the event generating unit 306b may decide whether to generate or not a release event in response to the release signal.

Referring back to FIG. 3, the control unit 202 may determine the gesture event or the combination of gesture events generated by the gesture recognition module 203 as a predefined gesture input. The gesture recognized by the gesture recognition module 203 does not necessarily match one-to-one with a gesture input to be specifically recognized by the control unit 202 based on the gesture event.

In exemplary embodiments, the control unit 202 may determine one gesture event (for example, left event) as one gesture input (for example, left input) and process the gesture event. The control unit 202 may determine that one gesture event should match with one gesture input. In some embodiments, the control unit 202 may determine the presence of an input only when a predefined condition is satisfied. For example, in the case of where a direction event has been generated, the control unit 202 may determine that there is a direction input corresponding to the direction event only when there is no cover input confirmed prior to the reception of a release event (that is, only when there is no history of cover input). For example, when both one or more direction events and at least one cover event have occurred (for example, events occur in the order of left event->cover event->right event->release event) prior to the occurrence of the release event, the control unit 202 may determine that there is only a cover input corresponding to the cover event by giving priority to the cover event and discarding the direction events.

In exemplary embodiments, the control unit 202 may combine a number of the same and/or different gesture events and use the combined gesture event to determine one gesture input. For example, if events are generated in the order of cover event, cover event and release event, the control unit 202 may determine that there is a first cover input. If events are generated in the order of cover event, cover event, cover event, cover event, cover event, cover event and an optional release event, the control unit 202 may determine that there is a second cover input. One or more direction events may be further included between the cover events or between the cover event and the release event, and the control unit 202 may discard the intervening direction events.

Further, the control unit 202 may determine a third cover input, a fourth cover input, and the like according to the number of consecutively generated cover events. In determining a particular cover input using the most consecutive cover events, it is not prerequisite that a release event subsequent to the last cover event be signaled. This is because any cover events following the consecutive cover events will only add to the number of total consecutive cover events, and thus the following cover events would not be used for determining a different cover input other than the particular cover input.

In exemplary embodiments, the control unit 202 may determine the presence of a wipe input, if a pair of consecutive opposite direction events, for example, left event->right event, right event->left event, up event->down event or down event->up event, is generated by the gesture recognition module 203. In this case, the control unit 202 may determine the presence of the wipe input upon the occurrence of the pair of consecutive opposite direction events, or only when a predefined condition is satisfied, for example, when it is confirmed that no cover input is input until a release event is received after a pair of consecutive opposite direction events was generated (that is, there is no history of cover input).

The control unit 202 may control the electronic device 200, more specifically, actions of applications or functions (for example, home screen, a browser, a multimedia player for images, music, video or the like, calls, a scheduler, mails, or various applications installed in the electronic device 200) running in the electronic device 200, to correspond to the determined gesture input. For example, the control unit 202 may consider the determined gesture input as a user input for a particular application or function running on a foreground, and control the application or the function to perform a predefined action corresponding to the gesture input.

The input/output unit 204 includes an input module allowing the input of data or input, instruction and request signals to the electronic device 200 and an output module allowing the output of data, information, and signal processed by the electronic device 200. The input module may include a camera for input of image/video signals, a microphone for input of voice or audio, a keypad, a dome switch, buttons, a jog wheel a touch pad, and the like, to input data, instruction and the like to the electronic device 200. The output module may include a display for outputting image signals or video signals, a speaker for outputting audio signals and/or an audio output device, such as an ear jack, an oscillator module for outputting a mechanical signal (for example, vibration), an infrared light emitter, and the like.

In addition, the electronic device 200 may include a touch screen 108 (refer to FIG. 1). The touch screen is one input/output device for interaction between the user and the electronic device 200, and serves as both a touch pad as an input module and a display as an output module. The touch screen may have a layered structure in which a touch pad as an input device and a display as an output device are coupled to each other, or an integrated structure in which the touch pad and the display are integrated into one form. The user may input instructions or information to the electronic device 200 by touching the touch screen directly or with a stylus pen. The electronic device 200 may output text, image and/or video through the touch screen.

In exemplary embodiments, the control unit 202 may output a result of recognition of a particular gesture input through the output module of the input/output unit 204. A method for outputting the recognition result is not limited and examples thereof may include haptic feedback, vibration, sound, or an icon displayed on the display.

The storage unit 206 stores applications and data required for operation and actions of the electronic device 200. The storage unit 206 may store various types of applications, for example, a number of function module programs and application programs, required for the control unit 202 to process and control other modules. In addition to the applications and data, the storage unit 206 may store data and information, such as, mails, text, images, videos, documents, music, phone numbers, call history, and messages. The type of storage unit 202 is not limited, and examples thereof may include random access memory (RAM), internal and/or external flash memory, magnetic disk memory, read only memory (ROM), and the like.

The storage unit 202 may store all or some of one or more gesture signals (direction signals and/or state signals) generated by the gesture recognition module 203 and all or some of one or more gesture events (direction events and/or state events). The storage unit 202 may temporarily store a direction event generated by the gesture recognition module 203 when the control unit 202 determines the occurrence of a direction input corresponding to the direction event in the absence of a history of a cover input.

The wireless communication unit 208 communicates with a wireless communication network and/or other electronic devices by transmitting and receiving electronic waves. The wireless communication unit 208 may conduct communications in accordance with one or more wireless communication protocols, and the number or type of the protocols is not limited.

The power supplying unit 210 provides each element of the electronic device 200 with power required for operation of the electronic device 200. The electronic device 200 may be equipped with a battery that may be detachable or integrated with the electronic device 200. The electronic device 200 may have a module for receiving power from an external power system. The electronic device 200 may include the power providing unit 210 for receiving power from an external power system.

The sensor unit 212 may include a gravity sensor, a proximity sensor, an acceleration sensor, and the like. The sensor unit 212 includes the photo sensor 214, which may be the same as the photo sensor 104 shown in FIGS. 1 and 2. The photo sensor 104 is already described with reference to FIGS. 1 and 2, and thus detailed description of the photo sensor 214 shown in FIG. 3 will be omitted.

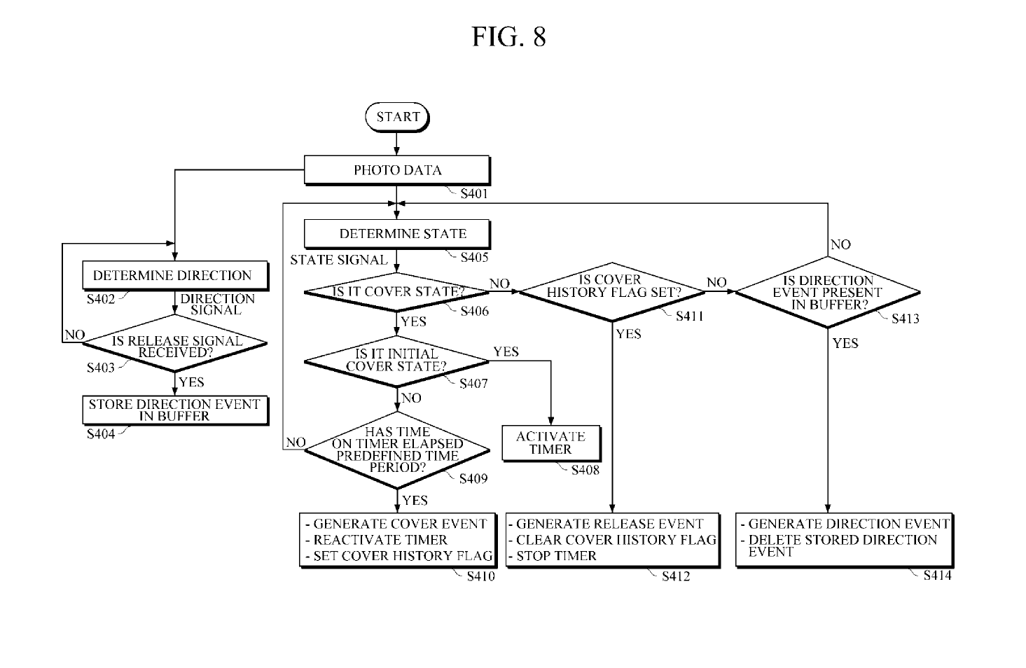

Hereinafter, a gesture recognition method of an electronic device including a photo sensor will be described with reference to FIG. 8. FIG. 8 is a flowchart illustrating a gesture recognition method for a photo sensor according to exemplary embodiments of the present invention. The method shown in FIG. 8 may be implemented in the gesture recognition module 203 described with reference to FIGS. 3 to 7. Hence, the gesture recognition method illustrated in FIG. 8 will be described in brief, and details omitted in the description of the gesture recognition method may be the same as provided with reference to FIGS. 3 to 7.

Photo data is input from a photo sensor in operation S401. The photo data may indicate the strength or the intensity of reflected light periodically received from an object. For example, the photo data may be four pieces of reflected light data received respectively from four unit light receivers 14a, 14b, 14c, and 14d of the photo sensor 104 shown in FIG. 1 or FIG. 2. However, aspects need not be limited thereto, such that the photo data may include fewer, for example, 2 or 3, or more, for example, 5, 6, or 8, channels of reflected light data.

By using the photo data received in operation S401, a motion of the object, that is, a moving direction thereof is determined in operation S402. Operation S402 may be performed in the direction determining unit 302 shown in FIG. 4. If the direction determination result satisfies a predetermined condition, for example, a direction signal that indicates a specific direction, a direction signal is generated. The direction signal may indicate, for example, one of four directions up, down, left, and right or may indicate one of more directions including directions of different angles. For example, the order of unit light receivers 14a, 14b, 14c and 14d corresponding to the intensity of the reflected light shown in FIGS. 5A to 5D the maximum value or changes in an X-axial variation and a Y-axial variation in the intensity of the reflected light shown in FIGS. 6A to 6D over time.

After the direction signal is generated in operation S402, it is determined whether a release signal is generated in operation S403. Operation S403 is optional. Operation S403 may be performed in the signal confirming unit 306a shown in FIG. 4. In operation S403, the signal confirming unit 306a may determine whether a release signal is received from the state determining unit 304 (refer to FIG. 4). If it is determined in operation S403 that there is no received release signal, operation S402 and subsequent operations are repeated with photo data newly generated in operation S401. If the determination result in operation S403 shows that the release signal has been received, a direction event is generated and stored in a buffer in operation S404. Operation S404 may be performed by the event generating unit 306b shown in FIG. 4.

In operation S405, it is determined, based on the received photo data in operation 401, whether the state of the object is a cover state or a release state. Operation S405 can be performed independent of or simultaneously with operation S402. Operation S405 may be performed by the state determining unit 304 shown in FIG. 4. If the determination result of operation S405 satisfies a predefined condition (for example, the sum of the intensity of the reflected light shown in FIGS. 6A to 6D being greater than or smaller than a threshold), a state signal (a cover signal or a release signal) that indicates a cover state or a release state may be generated.

In operation S406, it is determined whether the cover signal is generated. Operation 5406 may be performed by the signal confirming unit 306a shown in FIG. 4. The signal confirming unit 306a may determine whether a cover signal is received from the state determining unit 304.

If it is determined in operation S406 that the cover signal is received, that is, the object is in cover state, it is determined whether this cover state is an initial cover state in operation S407. Operation S407 may be performed in the event generating unit 306b shown in FIG. 4, which is provided for exemplary purpose only. If it is determined in operation S407 that the received cover signal is an initially received cover signal, a timer is activated in operation S408. The timer measures whether the time for which the cover signals are consecutively input lasts for a predefined period (that is, a duration required for generating a cover event, for which the cover states are consecutively maintained, for example, Tc shown in FIG. 7).

If it is determined in operation S407 that the received cover signal is not an initial cover signal, it is determined in operation S409 whether the predefined period Tc (refer to FIG. 7) has elapsed since the timer was activated in operation S408. Operation 5409 may be performed by the event generating unit 306b shown in FIG. 4. Operation S405 and the subsequent operations are repeated with photo data newly generated in operation S401, if it is determined in operation S409 that the predefined period has not yet elapsed since the activation of the timer.

If it is determined in operation S409 that the predefined period has elapsed since the activation of the timer, a cover event is generated in operation S410. Operation S410 may be performed by the event generating unit 306b shown in FIG. 4. Along with the generation of the cover event, the timer may be reactivated and a cover history flag may be set in operation S410. The cover history flag is to indicate the occurrence of the cover event, and the setting of the cover history flag indicates that the cover event has occurred.

If it is determined in operation S406 that the cover signal has not been received, that is, the object is not in cover state, it is determined whether the cover state is set in the cover history flag in operation S411. Operation S411 may be performed by the event generating unit 306b shown in FIG. 4. As described above, the cover history flag may be set in operation S410.

If it is determined in operation S411 that the cover history flag has been set, a release event is generated in operation S412. Operation S412 may be performed by the event generating unit 306b shown in FIG. 4. Operation S412 may be performed by the event generating unit 306b shown in FIG. 4. Upon generating the release event, the cover history flag may be cleared or deleted or the activating timer may be stopped in operation S412. The cover history flag is cleared to exclude the cover events generated before the generation of the release event in operation S412 from a future gesture recognition process and to indicate whether a new cover event is generated. In addition, the timer is stopped to be reactivated when the next cover state is determined as an initial cover state in operation S406 and S407.

If it is determined in operation S411 that the cover history event is not set, it is determined whether a direction event is stored in a buffer in operation S413. Operation S413 may be also performed by the event generating unit 306b shown in FIG. 4. If it is determined that no direction event is present in the buffer in operation S413, operation S405 and the subsequent operations are repeated with photo data newly generated in operation S401.

If it is determined in operation S413 that the direction event is present in the buffer, a direction event is generated in S414. Operation S414 may be performed by the event generating unit 306b of FIG. 4. Upon the generation of the direction event, the direction event stored in the buffer may be deleted. This decreases reuse of the direction event that has already been used for gesture recognition.

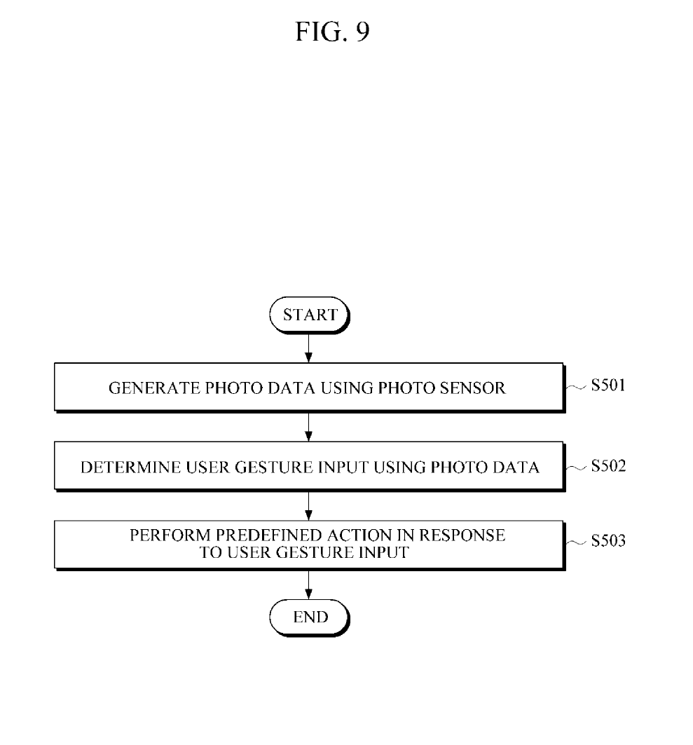

FIG. 9 is a flowchart illustrating a method for controlling an electronic device according to exemplary embodiments of the present invention. The method illustrated in FIG. 9 may be implemented in the electronic devices 100 and 200 described above with reference to FIGS. 1 to 8. Thus, the control method will be described in brief, and details not described herein may be the same as the description provided with reference to FIGS. 1 to 8.

Referring to FIG. 9, photo data for use in determining a motion or a state of an external object is generated by a photo sensor in operation S501. In operation S501, light (for example, IR light) may be emitted from an emitter in the photo sensor. The emitted light is reflected from the external object and one or more light receptors in the photo sensor receive the reflected light and generate the photo data based on the received reflected light.

In operation S502, the motion or a cover state of the object is determined as a is gesture input based on the photo data generated in operation S501. The gesture input includes a direction input and two or more types of cover inputs. The direction input indicates that the object moves upward, downward, left, or right relative to the photo sensor. The cover input indicates that the object was still for a predefined period at a predetermined location on a main path along which the light emitted from the photo sensor travels, with respect to the photo sensor. The cover input may vary in type according to the period for which the object pauses, that is, the length of the duration of the cover state.

In operation S503, a particular action of the electronic device is executed corresponding to the gesture input determined in operation S502. The action to be executed corresponding to the gesture input may be predetermined. The type of operation to be executed may vary depending on applications or functions running in the electronic device.

According to exemplary embodiments of the present invention, a cover state may be determined as two or more types of gesture inputs with different durations according to the lasting time of state, i.e. how long a gesture is maintained. The determined cover inputs may be utilized as a user interface of the electronic device. In some embodiments, the electronic device generates a number of cover events with intervals shorter than the duration of each cover input, and distinguishes types of the cover events by the number of cover events. Accordingly, the electronic device may expand the types of gesture inputs with cover inputs of various conditions (different durations) and such expansion may be implemented as software.

According the exemplary embodiments of the present invention, a release signal is used, one direction signal is selected from among a number of direction signals based on the release signal, or in the presence of both the direction signal and a cover signal, a priority is given to one of the signals and the signal with the priority is chosen over the rest. As a result, it is possible to decrease the occurrence of an error in gesture recognition even when small movements produce a significant amount of erroneous direction signals and/or state signals, for example, in a short period. Further, in determination of a gesture input, the release event is used to distinguish different types of cover inputs and the cover event and the direction event are selectively utilized, so that it is possible to decrease the occurrence of an error in recognizing a gesture.

Although a few exemplary embodiments of the present invention have been shown and described, the present invention is not limited to the described exemplary embodiments. Instead, it will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An electronic device comprising:
a gesture recognition module configured to receive reflected light data, configured to determine one or more of a motion and a cover state of an external object using the reflected light data, and configured to recognize the motion or the cover state as a gesture input type, wherein the gesture input type comprises two or more types of motions or cover inputs indicating different cover states of different durations; and
a processor configured to execute the gesture recognition module.

2. The electronic device of claim 1, wherein the gesture recognition module is configured to generate a wipe input as the gesture input type when consecutive opposite direction states are conveyed by the reflected light data.

3. The electronic device of claim 1, wherein the gesture recognition module is configured to determine a release state, and
the gesture input type further comprises one or more of a direction input, a release input, or a combination thereof.

4. The electronic device of claim 1, further comprising a control unit configured to execute a control in response to the determined gesture input type.

5. The electronic device of claim 1, wherein the gesture recognition module is configured to combine a number of same or different states and use the combined gesture state to determine the gesture input type.

6. The electronic device of claim 1, wherein the two or more types of cover inputs are consecutively generated.

7. The electronic device of claim 1, further comprising:
a photo sensor,
wherein the gesture recognition module comprises:
a direction determining unit configured to determine a moving direction of an external object using photo data generated by the photo sensor and to generate a direction signal indicating the determined moving direction,
a state determining unit configured to generate a cover signal when it is determined, based on the photo data, that the object is in the cover state and to generate a release signal when it is determined, based on the photo data, that the object is in a release state, and
a gesture recognizing unit configured to generate one or more events selected from a direction event, a cover event, and a release event using an input direction signal, a cover signal, and a release signal.

8. An electronic device comprising:
a gesture recognition module configured to receive reflected light data, configured to determine one or more of a motion, a release and a cover state of an external object using the reflected light data, and configured to recognize the motion, release or cover state immediately preceding the release state as a gesture input type; and
a processor configured to execute the gesture recognition module.

9. The electronic device of claim 8, wherein the gesture input type comprises one or more of a cover input, a multiple cover input, a direction input, a release input, or a combination thereof.

10. The electronic device of claim 9, wherein the gesture recognition module is configured to generate a cover input by discarding a direction state, when the reflected light data conveys both the direction state and the cover state before conveying the release state.

11. The electronic device of claim 9, wherein the gesture recognition module is configured to generate a direction input in response to a direction state being conveyed by the reflected light data subsequent to a cover state and prior to the release state, when a period required to generate a cover input has not elapsed prior to the direction state being conveyed.

12. The electronic device of claim 9, wherein the gesture recognition module is configured to generate a cover input in response to a direction state being conveyed by the reflected light data before or subsequent to a cover state and prior to the release state, when a period required to generate a cover input has elapsed prior to the release state being conveyed.

13. The electronic device of claim 9, wherein the gesture recognition module is configured to combine a number of same or different states and use the combined gesture state to determine the gesture input type.

14. A computer-implemented method of recognizing a gesture, the method comprising:
receiving, with the computer, reflected light data;
determining, with the computer, one or more of a motion and a cover state of an external object using the reflected light data; and
recognizing, with the computer, the motion or the cover state as a gesture input type, wherein the gesture input type comprises two or more types of motions or cover inputs indicating different cover states of different durations.

15. The method of claim 14, further comprising generating a wipe input as the gesture input type when consecutive opposite direction states are conveyed by the reflected light data.

16. The method of claim 14, wherein the gesture recognition module is configured to determine a release state, and
the gesture input type further comprises one or more of a direction input, a release input, or a combination thereof.

17. The method of claim 14, further comprising executing a control in response to the determined gesture input type.

18. The method of claim 14, further comprising combining a number of same or different states and using the combined gesture state to determine the gesture input type.

19. The method of claim 14, wherein the two or more types of cover inputs are consecutively generated.

20. A computer-implemented method of recognizing a gesture, the method comprising:
receiving reflected light data;
determining one or more of a motion, a release and a cover state of an external object using the reflected light data; and
recognizing the motion, release or cover state immediately preceding the release state as the gesture input type.

21. The method of claim 20, wherein the gesture input type comprises one or more of a cover input, a multiple cover input, a direction input, a release input, or a combination thereof.

22. The method of claim 21, further comprising generating a cover input by discarding a direction state, when the reflected light data conveys both the direction state and the cover state before conveying the release state.

23. The method of claim 21, further comprising generating a direction input in response to a direction state being conveyed by the reflected light data subsequent to a cover state and prior to the release state, when a period required to generate a cover input has not elapsed prior to the direction state being conveyed.

24. The method of claim 21, further comprising generating a cover input in response to a direction state being conveyed by the reflected light data before or subsequent to a cover state and prior to the release state, when a period required to generate a cover input has elapsed prior to the release state being conveyed.

25. The method of claim 21, further comprising combining a number of same or different states and use the combined gesture state to determine the gesture input type.
